(19) United States
(12) Patent Application Publication
(10) Pub. No.: US 2023/0351522 A1
(43) Pub. Date: Nov. 2, 2023

(54) SYSTEM FOR EVALUATING HAIL DAMAGE TO A STRUCTURE

(71) Applicant: Hailscale LLC, Minnetonka, MN (US)

(72) Inventors: Justin D. Bedford, Minnetonka, MN (US); Luke E. Lorence, Hopkins, MN (US); Scott R. Muhs, Randolph, MN (US); Brenden J. Greenwood, Eagan, MN (US)

(21) Appl. No.: 18/309,245

(22) Filed: Apr. 28, 2023

Related U.S. Application Data
(60) Provisional application No. 63/363,890, filed on Apr. 29, 2022.

(51) Int. Cl. G06Q 40/08; G06F 16/29

(52) U.S. Cl. CPC G06Q 40/08; G06F 16/29

(57) ABSTRACT

The system relates to evaluating hail damage to a structure and presenting the information to a user. The system for evaluating hail damage to a structure comprises a processor, and computer-readable memory. The computer readable memory is encoded with instructions that, when executed by the processor, cause the system to receive a location signal and an age of a structure. The system then accesses a database of past hailstorm events and retrieves a dataset of information for the location of the structure. The system then processes the dataset of information to select past hailstorm events that occurred during the age of the structure, generates a composite damage score for the location and the age of the structure, and sends a signal indicative of the composite damage score to a display device so as to provide notification of the composite damage score to a user.

### CROSS-REFERENCE TO RELATED APPLICATION(S)

This application claims the benefit of U.S. Provisional Application No. 63/363,890 filed Apr. 29, 2022, for “SYSTEM FOR EVALUATING HAIL DAMAGE TO A STRUCTURE,” are hereby incorporated by reference in their entirety.

### BACKGROUND

Structures can suffer from significant damage as a result of hailstorms. Owners of such buildings may be unaware of the damage if, for example, the hailstorm takes place at night, and/or the damage is not readily visible from the ground. In residential homes, a hailstorm may cause undesirable damage to roofing shingles or other exterior furnishings. Hence a system for evaluating hail damage to a structure is desirable.

### SUMMARY

A system for evaluating hail damage to a structure comprises a processor, and computer-readable memory. The computer readable memory is encoded with instructions that, when executed by the processor, cause the system to: receive, from an input device, a signal indicative of a location of the structure; obtain, based on the location of the structure, data corresponding to an age of the structure; access a database of past hailstorm events, wherein the database includes an index of intensity of the past hail storm events; retrieve, from the database of past hailstorm events, a dataset of information for the location of the structure; process the dataset of information to select past hail storm events that occurred during the age of the structure; generate a composite damage score for the location and the age of the structure based on the index of intensity for each of the selected past hailstorm events, wherein the composite damage score indicates a likelihood of damage to the structure during the age of the structure; and send a signal indicative of the composite damage score to a display device so as to provide notification of the composite damage score to a user.

### BRIEF DESCRIPTION OF THE DRAWINGS

FIG. 1 is a schematic diagram of a system for evaluating hail damage to a structure.

FIG. 2 is a method flowchart detailing the steps taken by the user within the system.

FIG. 3 is a method flowchart detailing the steps taken by the system when prompted by user input.

FIG. 4(A) depicts a screenshot of a potential embodiments of a graphical user interface for receiving and conveying information to a user.

FIG. 4(B) depicts another screenshot of a potential embodiment of a graphical user interface for receiving and conveying information to a user.

FIG. 4(C) depicts another screenshot of a potential embodiment of a graphical user interface for receiving and conveying information to a user.

FIG. 4(D) depicts another screenshot of a potential embodiment of a graphical user interface for receiving and conveying information to a user.

FIG. 4(E) depicts another screenshot of a potential embodiment of a graphical user interface for receiving and conveying information to a user.

### DETAILED DESCRIPTION

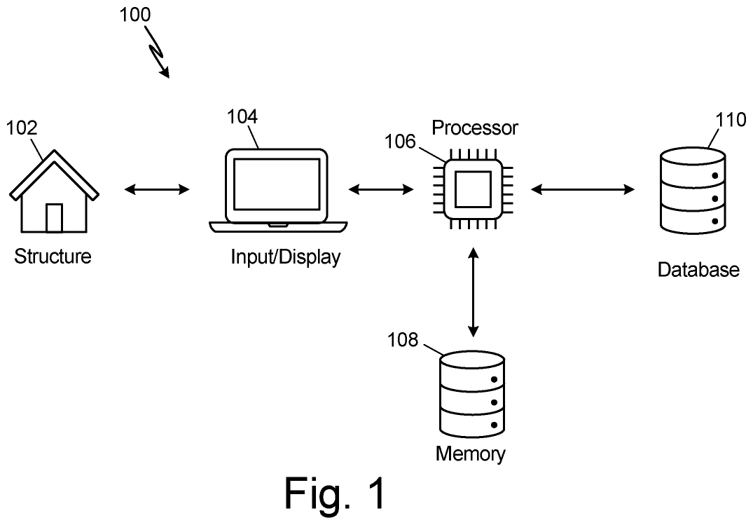

This application relates to evaluating damage to a structure that occurs as a result of hail fall. FIG. 1 is a schematic diagram of a system for evaluating hail damage to a structure. In FIG. 1, damage evaluation system 100 includes structure 102, input/display device 104, processor 106, computer-readable memory 108, and database 110. Information about structure 102 is recorded via input/display device 104. Computer-readable memory 108 is encoded with instructions that are executed by processor 106. Input/display device 104 conveys the information about structure 102 to processor 106. Processor 106 then pulls information from database 110 and sends it to input/display device 104 for display.

In such an embodiment, input/display device 104 is used to input parameters relating to structure 102. In some embodiments this input comprises an age of structure 102 and a location of structure 102. Processor 106, which executes instructions encoded within computer-readable memory 108, then receives information from input/display device 104 regarding the age of structure 102 and the location of structure 102. Processor 106 may then send a retrieval request to database 110, wherein database 110 may contain information regarding the severity of damage to structure 102. Processor 106 may then receive the information regarding the damage to structure 102 and display such information on input/display device 104.

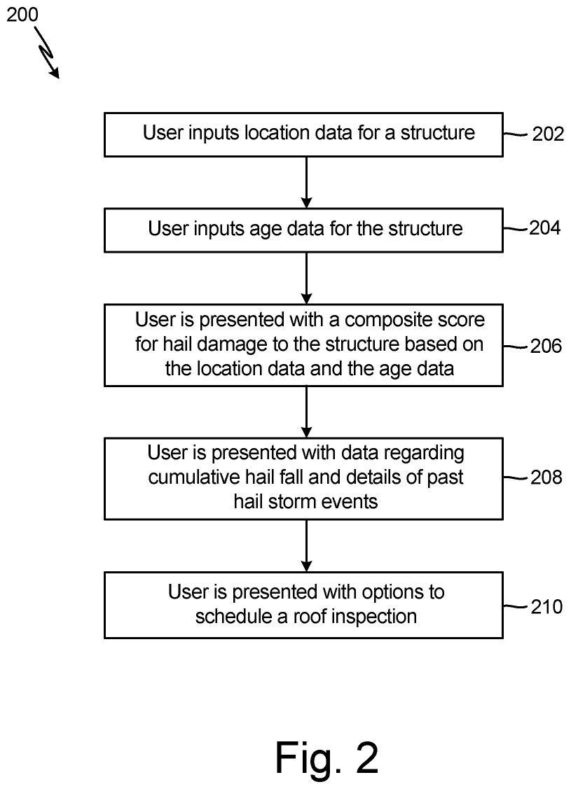

FIG. 2 is a method flowchart detailing one embodiment of the steps taken by a user engaging with the system in user process 200. User process 200 begins at step 202 in which a user inputs location data for a structure. At step 204, the user inputs age data for the structure. At step 206, the user is presented with a composite score for hail damage to the structure based on the location data and the age data. At step 208, the user is presented with data regarding cumulative hail fall and details of past hailstorm events. Finally, at step 210, the user is presented with options to schedule a roof inspection.

In some embodiments, step 202 is automated based on location data provided by the input/display device 104. For example, input/display device 104 could provide location data without user input if input/display device 104 has the ability to determine its location based on commonly available location services, such as Global Positioning Services, known location of a Wi-Fi connection, location provided by a telecommunications provider, or location service. In some embodiments, step 204 is automated based on the user input for location data of the structure. In such an embodiment, the system may obtain age data for the structure from an external database containing information regarding structure age based on location. Examples of external databases that could contain information regarding structure age include commercial real estate databases such as Zillow.com, realtor.com, or any such database; governmental databases such as local government (e.g., county, town, or other government entity) real estate appraisal databases; or other databases that include information regarding structure age based on location. In other embodiments, the age of the structure defaults to a maximum age value. For example, the maximum age value could be set at an arbitrary age, for example, 5 years, 10 years, 15 years, or more or less, depending on a judgment of the time frame that would be of interest to a user. In still other embodiments, the age of the structure may be obtained by the system based on the average age of surrounding structures or information about when the structure was last repaired. In some embodiments, at step 208, the user is presented with various parameters comprising cumulative hail fall, details of past storm events, average size of hail fall, average intensity of hail fall, and speed of previous storm events. Any combination of the listed parameters may be presented to the user at step 208.

In some embodiments, the composite score presented to the user in step 206 is presented in a defined cumulative score range. The defined cumulative score range may be indicative of the necessity of action on the part of the user. In one embodiment, the defined cumulative score ranges may indicate that no action is needed, that the structure should be monitored, or that the structure is at a high risk of damage. In some embodiments, step 210 is contingent on the defined cumulative score range presented to the user in step 206. Step 210 may only apply if the defined cumulative score range indicates the structure should be monitored or that the structure is at a high risk of damage. In other embodiments, step 210 applies regardless of the defined cumulative score range.

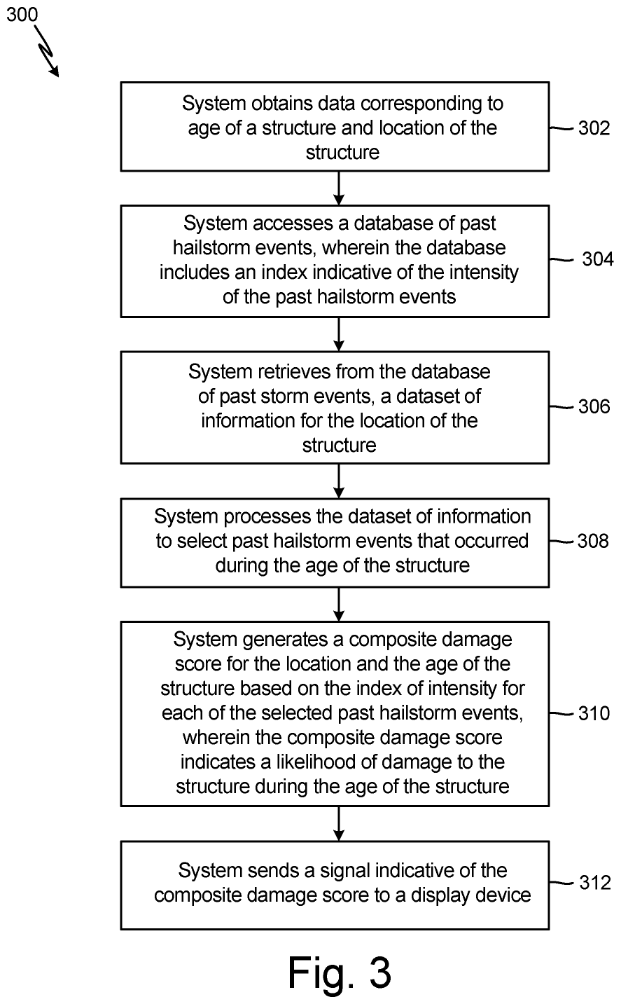

FIG. 3 is a method flowchart detailing the steps taken by a system when prompted by user input in system process 300. System process occurs within processor 106 of FIG. 1. Computer-readable memory 108 is encoded with instructions that, when executed by the processor, cause damage evaluation system 100 to go through system process 300. System process 300 begins at step 302, in which the system obtains data corresponding to age of a structure and location of the structure. At step 304, the system accesses a database of past hailstorm events, wherein the database includes an index of the intensity of the past hailstorm events. In some embodiments, the index of the intensity of past hailstorm events is determined based on parameters comprising a storm speed and a storm angle.

At step 306, the system retrieves from the database of past storm events, a dataset of information for the location of the structure. The dataset of information may include information regarding past storm events comprising: a date, a duration, a hail size, the index of intensity, a storm speed, and a storm direction. In some embodiments, step 306 may rely on government databases, such as databases accessible through the National Centers for Environmental Information (part of the National Ocean and Atmospheric Administration (NOAA)), other NOAA databases, and other databases maintained by local, state, and national government agencies in the United States and other countries; commercial databases, such as those available from Meteomatics, Verisk, StormerSite, Hail-Mail, Dynamic Weather Solutions, and other commercial providers; and private or self-maintained databases. For example, the databases disclosed in U.S. Pat. Nos. 9,678,206 and 10,436,894 and US Published Patent Application US20210019847A1, the disclosures of which are incorporated into this application by reference, could be useful for step 306 (and potentially other steps of FIG. 3).

At step 308, the system processes the dataset of information to select past hailstorm events that occurred during the age of the structure. In one embodiment, at step 310, the system may generate a composite damage score for the location and the age of the structure based on the index of intensity for each of the selected past hailstorm events, wherein the composite damage score indicates a likelihood of damage to the structure during the age of the structure. In one embodiment, at step 310 the system may generate the composite score by calculating a cumulative score based on the storm duration and the index of intensity, scaling the cumulative score to a gross rating based on one or more defined cumulative score ranges, and adjusting the gross rating based on the date of the one or more past storm events to produce the composite damage score. In some embodiments, the gross rating may be adjusted higher for more recent storm events, or adjusted lower or not adjusted at all for less recent storm events. In another embodiment, the system may generate the composite score by calculating a cumulative score based on the storm duration and hail size, then scaling the cumulative score to a gross rating based on one or more defined cumulative score ranges. In such an embodiment, the system may also adjust the gross rating based on the date of the one or more past storm events. In still other embodiments, the system can use any combination of parameters obtained from the dataset of information for the location of the structure to calculate a cumulative score. Further, the system can weight the importance of such factors with varying impact on the calculated cumulative score.

Finally, at step 312, the system sends a signal indicative of the composite damage score to a display device.

In some embodiments, the method of FIG. 3 can comprise the additional steps of determining an updated composite damage score based on a visual inspection of the structure, and refining a system process for determining the composite damage score based on the updated composite damage score from the visual inspection of the structure. In such an embodiment, the structure is visually inspected, and an updated damage score is recorded. The system can then refine its calculation of the composite damage score. In one embodiment, this refinement may be a higher adjustment to the composite damage score based on the recency of the storm event. In other embodiments, the parameters obtained from the dataset of information for the location of the structure may be weighted differently in the composite score calculation. In still other embodiments, the refinement may be increasing or decreasing the composite score by a constant value. In still other embodiments, the visual inspection may match the initial composite score and hence no refinement is performed.

In some embodiments wherein the visual inspection is conducted, and the system process is refined, the system may also refine the bounds of the one or more cumulative score ranges. In such an embodiment, a cumulative score range maybe adjusted by the system such that a composite score is placed in a lower score range or a higher score range based on the visual inspection.

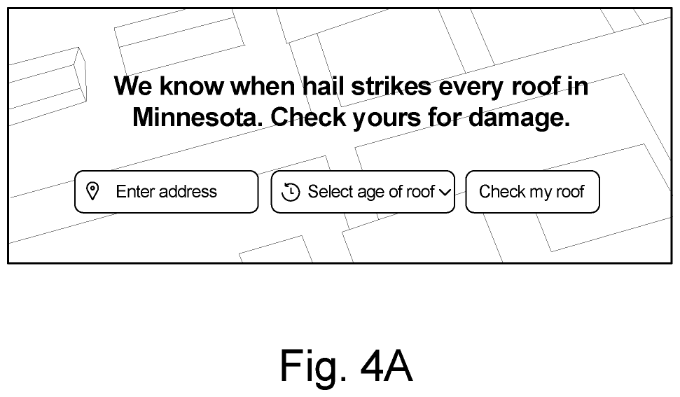

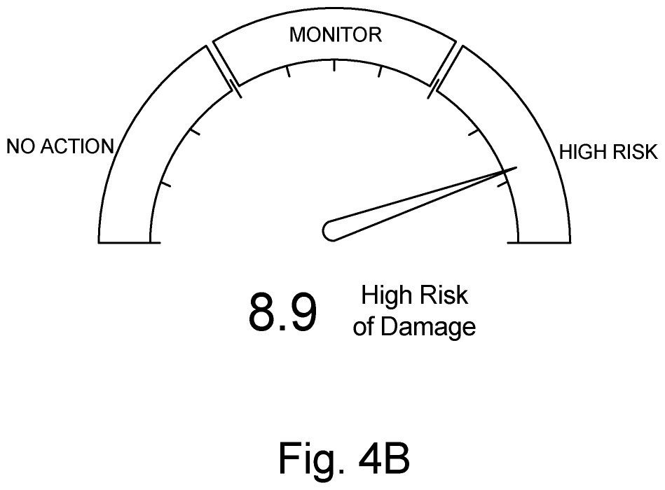

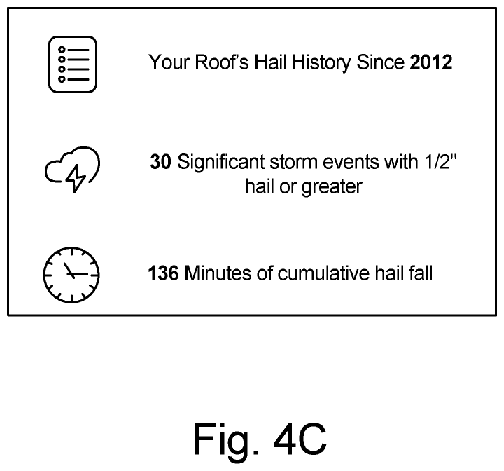

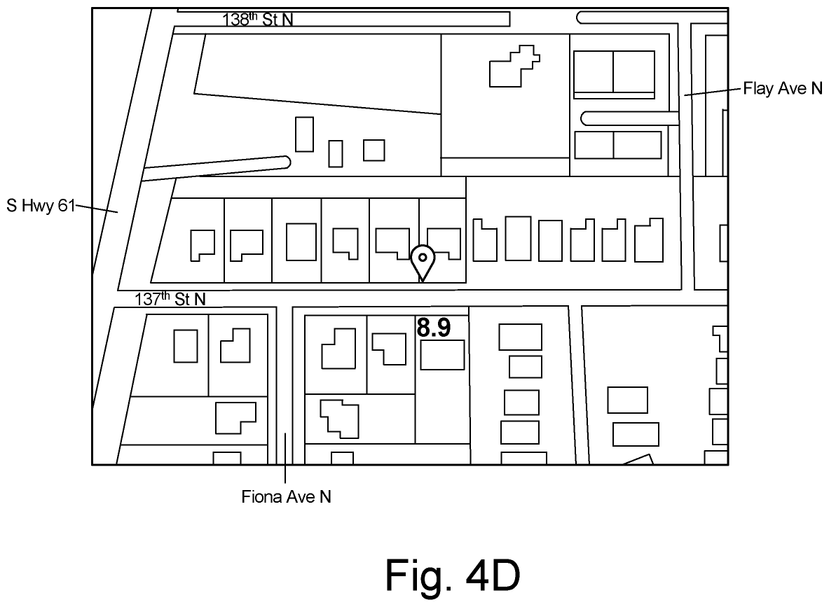

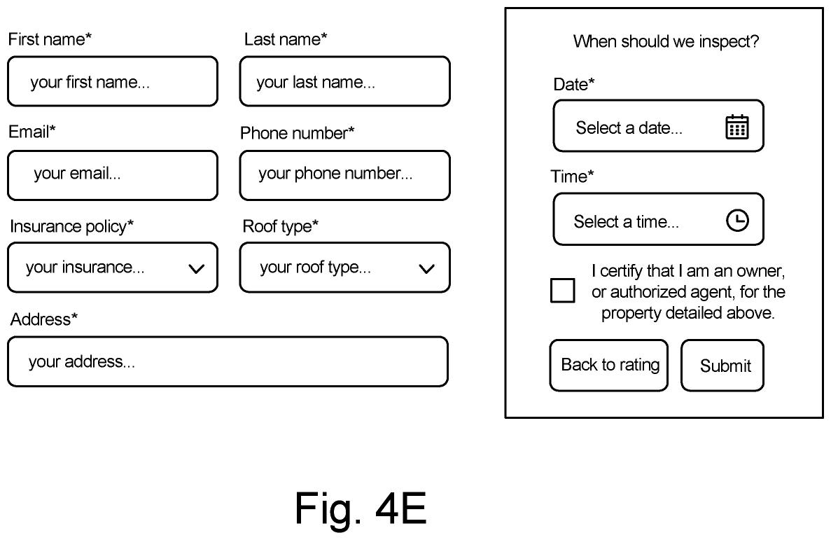

FIGS. 4(A)-4(E) depict screenshots of potential embodiments of a graphical user interface for receiving and conveying information to a user. FIG. 4(A) depicts a possible embodiment for a method of obtaining age and location information for a structure using input/display device 104 from FIG. 1. In such an embodiment, a user may enter the age of the structure and the location of the structure using an input device. The location of the structure may be a specific address. The age of the structure may be an age of a roof of the structure measured in years. In such an embodiment, the input for the age of the roof of the structure measured in years may be limited to a value with a minimum of zero years, and a maximum of a difference between a present year and a first year of data collection from the database of past hailstorm events or an arbitrary time (e.g., 5 years, 10 years, 15 years, or other times) that reflect a judgment on the usefulness of longer or shorter time frames. In other embodiments, the user may input only the location of the structure. In such an embodiment, the age of the structure may be retrieved by the system from a database comprising information related to the age of structures at given locations.

FIG. 4(B) depicts a possible embodiment for displaying, on input/display device 104 of FIG. 1, a composite damage score to a user. In such an embodiment, the composite damage score is presented numerically and ranges from 0.0 to 10.0. The composite damage score may be presented within three defined cumulative score ranges on a meter. The defined cumulative score ranges indicate to the user either that there is no action needed, the structure should be monitored, or that there is a high risk of damage to the structure. In other embodiments, there can be two or more defined cumulative score ranges. In other embodiments, the two or more defined cumulative score ranges can indicate varying levels of attention needed to the structure being evaluated. In still other embodiments, the two or more defined cumulative score ranges may be presented on other graphical display tools including, but not limited to, a chart or a scale.

FIG. 4(C) depicts a possible embodiment for displaying information, on input/display device 104 of FIG. 1, regarding the structure to a user. In such an embodiment, the user is notified of information corresponding to the age of the roof, as gathered from the input device in FIG. 4(A). The user may be notified of the number of significant storm events. The user may also be notified of cumulative time of hail fall across the life of the roof. In other embodiments, different information may be presented to the user. Such information is drawn from database 110 in FIG. 1 and processed to be shown to the user in a readable format.

FIG. 4(D) depicts a possible embodiment wherein the input/display device 104 of FIG. 1 presents a map overlay comprising a composite damage score. In other embodiments, the map overlay may show the composite damage score of surrounding structures. FIG. 4(E) depicts a possible embodiment wherein the input/display device presents the user with the option to schedule an inspection of their structure based on a damage evaluation. In such an embodiment, the user is prompted to enter parameters using input/display device 104.

### Discussion of Possible Embodiments

The following are non-exclusive descriptions of possible embodiments of the present invention.

System related to evaluating hail damage to a structure. A system for evaluating hail damage to a structure comprises a processor, and computer-readable memory. The computer readable memory is encoded with instructions that, when executed by the processor, cause the system to: receive, from an input device, a signal indicative of a location of the structure; obtain, based on the location of the structure, data corresponding to an age of the structure; access a database of past hailstorm events, wherein the database includes an index of intensity of the past hail storm events; retrieve, from the database of past hailstorm events, a dataset of information for the location of the structure; process the dataset of information to select past hail storm events that occurred during the age of the structure; generate a composite damage score for the location and the age of the structure based on the index of intensity for each of the selected past hailstorm events, wherein the composite damage score indicates a likelihood of damage to the structure during the age of the structure; and send a signal indicative of the composite damage score to a display device so as to provide notification of the composite damage score to a user.

The system of the preceding paragraph can optionally include, additionally and/or alternatively, any one or more of the following features, configurations and/or additional components:

A further embodiment of foregoing system, wherein the dataset of information for the location of the structure comprises a date, a duration, a hail size, the index of intensity, a storm speed, and a storm direction.

A further embodiment of the foregoing system, wherein the system generates the composite damage score by performing the steps of: calculating a cumulative score based on the storm duration and the index of intensity; scaling the cumulative score to a gross rating based on one or more defined cumulative score ranges; and adjusting the gross rating based on the date of the one or more past storm events to produce the composite damage score.

A further embodiment of the foregoing system, wherein the one or more defined cumulative score ranges comprise two or more ranges.

A further embodiment of the foregoing system, wherein the system generates the composite damage score by further performing the steps of: determining an updated composite damage score based on a visual inspection of the structure; and refining a system process for determining the composite damage score based on the updated composite damage score from the visual inspection of the structure.

A further embodiment of the foregoing system, wherein the system generates the composite damage score by further performing the steps of: refining one or more bounds of the one or more defined cumulative score ranges in response to an adjustment of the composite damage score based on the visual inspection of the structure.

A further embodiment of the foregoing system, wherein one of the defined cumulative score ranges indicates no action needed, one of the defined cumulative score ranges indicates the structure should be monitored, and one of the defined cumulative score ranges indicates the structure is at a high risk of damage.

A further embodiment of the foregoing system, wherein the computer-readable memory is further encoded with instructions that, when executed by the processor, cause the system to: prompt a user with one or more actions to be taken in response to which of the defined cumulative score ranges applies.

A further embodiment of the foregoing system, wherein the index of intensity is determined based on parameters comprising the storm speed and a storm angle.

A further embodiment of the foregoing system, wherein the signal indicative of the location of the structure is an address.

A further embodiment of the foregoing system, wherein the data corresponding to the age of the structure is a roof age measured in years.

A further embodiment of the foregoing system, wherein the roof age measured in years can be a value with a minimum of 0 years and a maximum of the difference between a present year and a first year of data collection from the database of past hailstorm events.

A further embodiment of the foregoing system, wherein the composite damage score ranges from 0.0 to 10.0.

A further embodiment of the foregoing system, wherein the display device presents a map overlay comprising the composite damage score.

A further embodiment of the foregoing system, wherein the map overlay comprises the composite damage score of surrounding structures.

A further embodiment of the foregoing system, wherein the display device presents a meter with the composite score displayed within the one or more defined cumulative score ranges.

A further embodiment of the foregoing system, wherein the display device presents a history of past hailstorm events.

A further embodiment of the foregoing system, wherein the display device presents a cumulative duration of hail fall based on the dataset of information comprising past hailstorm events that occurred during the age of the structure.

A further embodiment of the foregoing system, wherein the system generates the composite damage score by performing the steps of: calculating a cumulative score based on the storm duration and the hail size; scaling the cumulative score to a gross rating based on one or more defined cumulative score ranges; and adjusting the gross rating based on the date of the one or more past storm events to produce the composite damage score.

A further embodiment of the foregoing system, wherein the computer-readable memory is further encoded with instructions that, when executed by the processor, cause the system to generate an alert to inform the user when a future hailstorm occurs.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for evaluating hail damage to a structure, the system comprising:
a processor; and
computer-readable memory encoded with instructions that, when executed by the processor, cause the system to:
receive, from an input device, a signal indicative of a location of the structure;
obtain, based on the location of the structure, data corresponding to an age of the structure;
access a database of past hailstorm events, wherein the database includes an index of intensity of the past hailstorm events;
retrieve, from the database of past hailstorm events, a dataset of information for the location of the structure;
process the dataset of information to select past hailstorm events that occurred during the age of the structure;
generate a composite damage score for the location and the age of the structure based on the index of intensity for each of the selected past hailstorm events, wherein the composite damage score indicates a likelihood of damage to the structure during the age of the structure; and
send a signal indicative of the composite damage score to a display device so as to provide notification of the composite damage score to a user.

2. The system of claim 1, wherein the dataset of information for the location of the structure comprises a date, a duration, a hail size, the index of intensity, a storm speed, and a storm direction.

3. The system of claim 2, wherein the system generates the composite damage score by performing the steps of:
calculating a cumulative score based on the storm duration and the index of intensity;
scaling the cumulative score to a gross rating based on one or more defined cumulative score ranges; and
adjusting the gross rating based on the date of the one or more past storm events to produce the composite damage score.

4. The system of claim 3, wherein the one or more defined cumulative score ranges comprise two or more ranges.

5. The system of claim 4, wherein the system generates the composite damage score by further performing the steps of:
determining an updated composite damage score based on a visual inspection of the structure; and
refining a system process for determining the composite damage score based on the updated composite damage score from the visual inspection of the structure.

6. The system of claim 5, wherein the system generates the composite damage score by further performing the steps of:
refining one or more bounds of the one or more defined cumulative score ranges in response to an adjustment of the composite damage score based on the visual inspection of the structure.

7. The system of claim 3, wherein one of the defined cumulative score ranges indicates no action needed, one of the defined cumulative score ranges indicates the structure should be monitored, and one of the defined cumulative score ranges indicates the structure is at a high risk of damage.

8. The system of claim 7, wherein the computer-readable memory is further encoded with instructions that, when executed by the processor, cause the system to:
prompt a user with one or more actions to be taken in response to which of the defined cumulative score ranges applies.

9. The system of claim 2, wherein the index of intensity is determined based on parameters comprising the storm speed and a storm angle.

10. The system of claim 1, wherein the signal indicative of the location of the structure is an address.

11. The system of claim 1, wherein the data corresponding to the age of the structure is a roof age measured in years.

12. The system of claim 11, wherein the roof age measured in years can be a value with a minimum of 0 years and a maximum of a difference between a present year and a first year of data collection from the database of past hailstorm events.

13. The system of claim 1, wherein the composite damage score ranges from 0.0 to 10.0.

14. The system of claim 1, wherein the display device presents a map overlay comprising the composite damage score.

15. The system of claim 14, wherein the map overlay comprises the composite damage score of surrounding structures.

16. The system of claim 4, wherein the display device presents a meter with the composite damage score displayed within the one or more defined cumulative score ranges.

17. The system of claim 1, wherein the display device presents a history of past hailstorm events.

18. The system of claim 1, wherein the display device presents a cumulative duration of hail fall based on the dataset of information comprising past hailstorm events that occurred during the age of the structure.

19. The system of claim 2, wherein the system generates the composite damage score by performing the steps of:
calculating a cumulative score based on the storm duration and the hail size;
scaling the cumulative score to a gross rating based on one or more defined cumulative score ranges; and
adjusting the gross rating based on the date of the one or more past storm events to produce the composite damage score.

20. The system of claim 1, wherein the computer-readable memory is further encoded with instructions that, when executed by the processor, cause the system to:
generate an alert to inform the user when a future hailstorm occurs.
